(19) United States
(12) Patent Application Publication
(10) Pub. No.: US 2019/0297437 A1
(43) Pub. Date: Sep. 26, 2019

(54) DEVICE FOR MAINTAINING A HEARING AID WITH A RECHARGEABLE BATTERY

(71) Applicant: MG DEVELOPPEMENT, Perols (FR)

(72) Inventor: Jose GIL, Perols (FR)

(21) Appl. No.: 16/360,476

(22) Filed: Mar. 21, 2019

(30) Foreign Application Priority Data
Mar. 22, 2018 (FR) 18 52501

(51) Int. Cl. H04R 25/00

(52) U.S. Cl. CPC H04R 25/556; H04R 25/602; H04R 2460/17; H04R 2225/55; H04R 2225/31

(57) ABSTRACT

The device for maintaining at least one hearing aid equipped with a rechargeable battery includes a casing with at least one plate for receiving the hearing aid and with a dryer. The casing also includes a connection compartment for removably receiving a device for recharging the rechargeable battery of the hearing aid. The device for recharging is connected to the casing via an electronic connector for transmitting an electric current and/or a data exchange. The invention further relates to a maintenance kit having the device for recharging and the device for maintaining.

### CROSS-REFERENCE TO RELATED APPLICATIONS

See Application Data Sheet.

### STATEMENT REGARDING FEDERALLY SPONSORED RESEARCH OR DEVELOPMENT

Not applicable.

### THE NAMES OF PARTIES TO A JOINT RESEARCH AGREEMENT

Not applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not applicable.

### STATEMENT REGARDING PRIOR DISCLOSURES BY THE INVENTOR OR A JOINT INVENTOR

Not applicable.

### BACKGROUND OF THE INVENTION

### 1. Field of the Invention

The present invention falls within the field of maintaining a hearing aid, and more particularly the field of drying a hearing aid and recharging the rechargeable batteries thereof.

### 2. Description of Related Art including Information Disclosed under 37 CFR 1.97 and 37 CFR 1.98

When worn on an everyday basis, a hearing aid is regularly exposed to moisture. This moisture may be due to perspiration, earwax or ambient humidity. However, accumulation of moisture may lead to premature oxidization of the electronic components of the hearing aid and bring about premature degradation of the hearing aid.

To ensure proper operation of the hearing aid and increase the service life thereof, it is necessary to maintain it regularly. Everyday maintenance of a hearing aid may consist of dehumidification and disinfection of the hearing aid.

For this purpose, there is a plurality of technical solutions that make it possible to dry and disinfect a hearing aid.

In general, a device for drying a hearing aid comprises a casing equipped with a cover that is movable between an open position and a closed position. The casing comprises, on the one hand, a drying enclosure in which the hearing aid is placed and, on the other hand, drying means for drying the hearing aid. The drying means may be formed by one or more air inlets arranged on a first side of the casing and one or more outlets arranged on a second side of the casing.

There are also devices for drying hearing aids that carry a fan to accelerate the airflow generated between an air inlet and an air outlet.

Moreover, some drying devices carry a UV-C lamp so as to disinfect the hearing aid by electromagnetic irradiation.

In a parallel manner, the development of rechargeable battery or accumulator technologies is leading the makers of hearing aids to integrate rechargeable batteries into the new hearing aids being placed on the market.

Therefore, to make it possible for the user to recharge the batteries of his hearing aids, specific chargers for hearing aids are also appearing on the market.

There are basically two types of chargers for hearing aids: a type of chargers using electric contact and a type of contact-free chargers that operate primarily using magnetic resonance.

In this context, to facilitate the maintenance of hearing aids, the applicant has developed a technical solution that makes it possible to dry and recharge a hearing aid using a single device. This technical solution has also been developed with the object of being suitable for all types of hearing aids found on the market.

This approach has also led the applicant to optimize the design of the hearing aid drying system carried by the maintenance device.

### BRIEF SUMMARY OF THE INVENTION

The present invention relates to a device for maintaining at least one hearing aid that is equipped with a rechargeable battery, the maintenance device comprising a casing having a base equipped with a cover mounted movable between an open position and a closed position in which the internal space of the casing defines a maintenance enclosure, the casing comprising a plate for receiving a hearing aid and means for drying the hearing aid.

The maintenance device is characterized in that the casing comprises, at the maintenance space, a connection compartment internally comprising an electronic connector for transmitting an electric current and/or a data exchange, the connection compartment being suitable for removably receiving a device for recharging the rechargeable battery of the hearing aid, the recharging device being connected to the casing via the electronic connector.

Advantageously, the user can thus carry, within the connection compartment of the maintenance device, the specific recharging device for his hearing aids that was provided to him by the maker upon the purchase of his hearing aids. The electronic connector and the position of the connection compartment contribute to providing the user with a simple plug-and-play connection between the maintenance device and a specific recharging device for the hearing aid.

In accordance with a first feature of the invention, the recharging device is connected to electronic means that control, on the one hand, the drying means for creating an airflow that brings about the drying of the hearing aid and, on the other hand, a recharging device when it is connected to the electronic connector.

In accordance with a second, optional feature of the invention, the drying means comprise a fan for accelerating the circulation of an airflow that enters the casing.

In accordance with a third feature of the invention, the drying means comprise an air entry orifice and an air evacuation orifice that are configured to create an airflow, the air entry orifice being arranged at a lower face of the casing whilst the air evacuation orifice is arranged laterally with respect to the casing. Advantageously, the air evacuation orifice is arranged at the cover, the air evacuation orifice preferably being arranged at a hinge that articulates the cover with respect to the casing.

In accordance with a fourth feature of the invention, the drying means comprise a system for heating an incoming airflow. Preferably, the heating system is arranged in a heating chamber. Preferably, the heating chamber is arranged below the maintenance space; the heating chamber may also comprise a temperature sensor to regulate the temperature of an airflow in the casing, the temperature sensor being located in the vicinity of the heating system.

Moreover, on the one hand, the heating chamber is open to the exterior of the casing via an air entry orifice and, on the other hand, the heating chamber communicates with the maintenance enclosure via at least one opening.

Preferably, the air entry orifice, the heating system and the opening are arranged coaxially, and thus contribute to the generation of a rising airflow that experiences turbulence when it arrives in the maintenance space.

In accordance with a fifth feature of the invention, the maintenance device comprises a disinfection module for disinfecting the hearing aid by electromagnetic irradiation, the disinfection module being arranged at the cover.

To protect the user from the electromagnetic irradiation of the disinfection module if the cover is opened during a maintenance cycle, the maintenance device comprises a contact breaker for, on the one hand, powering the disinfection module when the cover is in the closed position and, on the other hand, cutting the power supply to the disinfection module when the cover is open.

The invention also relates to a kit for maintaining at least one hearing aid comprising, on the one hand, a recharging device and, on the other hand, a maintenance device according to the invention.

The maintenance kit is characterized in that the maintenance device comprises a connection compartment that internally comprises an electronic connector for transmitting an electric current and/or a data exchange, the connection compartment being suitable for removably receiving a device for recharging the rechargeable battery of the hearing aid, the recharging device being connected to the casing via the electronic connector.

### BRIEF DESCRIPTION OF THE SEVERAL VIEWS OF THE DRAWINGS

Further details and advantages will be apparent from the following detailed description of three non-limiting embodiments of the invention, which are illustrated in the accompanying FIGS. 1 to 7.

FIG. 1 is a schematic view of a maintenance device in accordance with the invention.

FIG. 2 is a perspective view of the maintenance device in accordance with a first embodiment of the invention, in which the maintenance device carries a recharging device of the type using electric contract.

FIG. 3 is a perspective longitudinal sectional view of the maintenance device of FIG. 2.

FIG. 4 is a perspective cross sectional view of the maintenance device of FIG. 2.

FIG. 5 is a perspective view of a maintenance device in accordance with a second embodiment of the invention, in which the maintenance device carries a recharging device of the type free of electric contact.

FIG. 6 is a perspective cross sectional view of a maintenance device in accordance with FIG. 5.

FIG. 7 is a perspective view of a maintenance device in accordance with a third embodiment of the invention, in which the maintenance device carries a recharging device of the type free of electric contact and having a sliding cover for the maintenance device.

### DETAILED DESCRIPTION OF THE INVENTION

The present invention relates to a device 1 for maintaining at least one hearing aid 2 equipped with a rechargeable battery. Preferably, the maintenance device 1 is suitable for receiving two hearing aids 2.

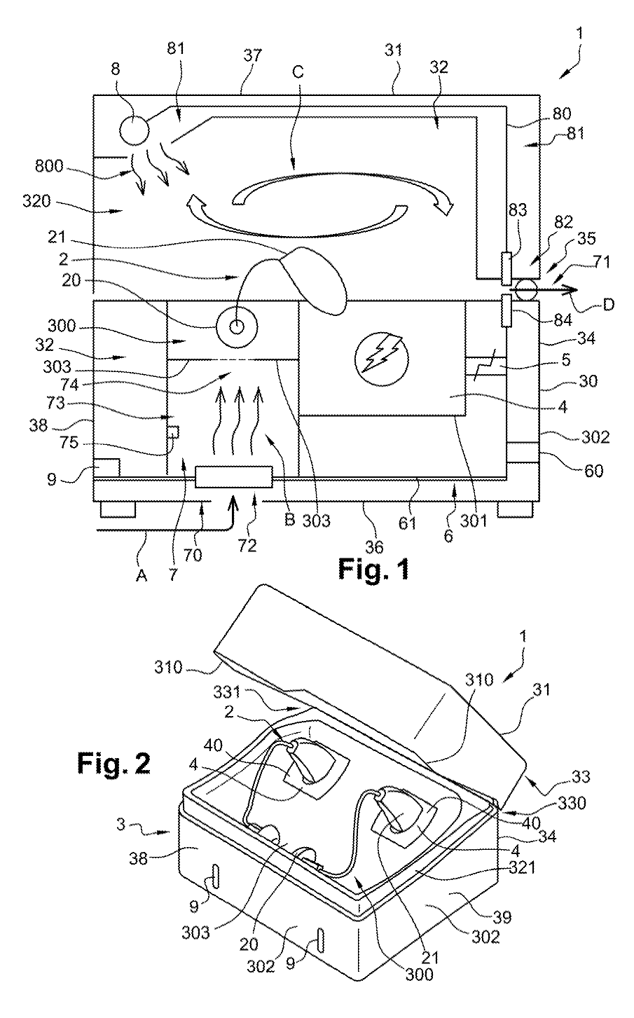

As is shown in FIGS. 1 to 7, the maintenance device 1 comprises a casing 3 having a base 30 equipped with a cover 31. The cover 31 is mounted movable between an open position and a closed position in which the internal space 32 of the casing 3 defines a maintenance enclosure 320.

In the example of FIGS. 1 to 6, the cover 31 is articulated with respect to the casing 3 via a hinge 33. In the present case, the hinge 33 is arranged on a rear face 34 of the casing 3 and forms a joining zone 35 between the casing 3 and the cover 31. In this example, the casing 3 has a parallelepiped shape. Thus, the casing 3 comprises a lower face 36 opposite an upper face 37 that is formed by the outer face of the hood of the cover 31. The casing also comprises a front face 38 opposite the rear face 34 and two side faces 39.

In the example shown in FIGS. 1 to 3, the hearing aid 2 is formed by an intra-auricular end piece 20 and an ear contour 21. Typically, the ear contour 21 carries the rechargeable battery of the hearing aid 2.

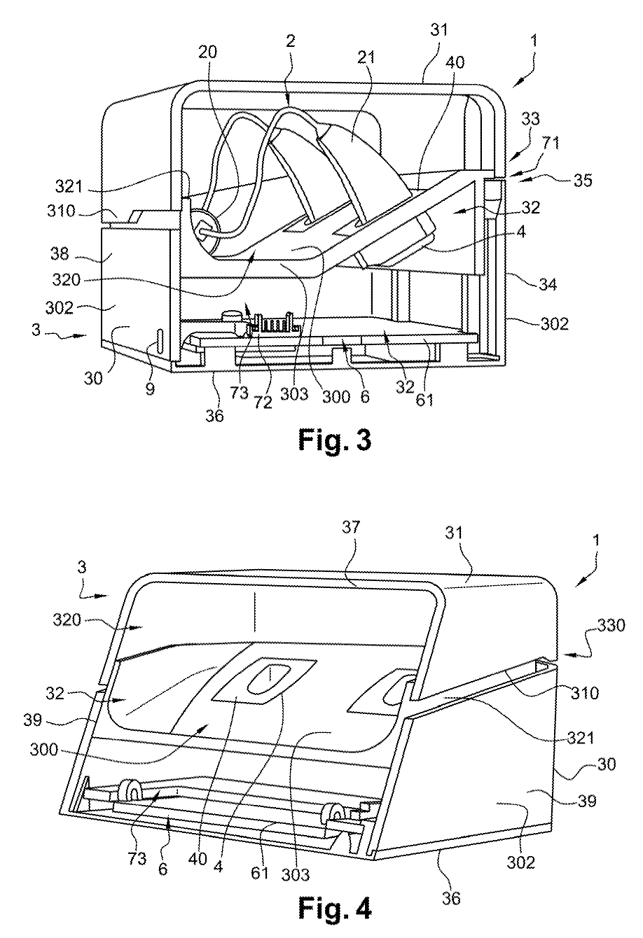

So as to receive the hearing aid 2, the casing 31 comprises a receiving plate 300 that makes it possible to receive at least one hearing aid 2 and preferably two hearing aids 2. So as to be easily accessible to the user, the receiving plate 300 is arranged in an upper part of the base 30. More particularly, the receiving plate 300 delimits the base 30 from above. As is shown in FIGS. 3 to 5, the maintenance space 320 is delimited from below by the receiving plate 300 and from above by the cover 31.

As is shown in FIG. 1, the casing 3 comprises a connection compartment 301 for removably receiving a recharging device 4 of the rechargeable battery of the hearing aid 2. Advantageously, the connection compartment 301 is arranged in the receiving plate 300.

As is shown in FIGS. 1 to 5 and 7, the recharging device 4 comprises a housing 40 for receiving at least part of the hearing aid 2. In the present case, the housing 40 receives the ear contour 21 for the purpose of recharging the rechargeable battery of the hearing aid 2.

The recharging device 4 is connected to the casing 3 via an electronic connector 5. The electronic connector 5 is suitable for transmitting an electric current and/or a data exchange. For example, the electronic connector 5 may be formed by a USB connector. However, the electronic connector 5 may be formed by other types of electronic connector: USB-A, USB-B, USB-C, USB-Micro, USB-Mini, HDMI-Micro, HDMI-Mini, HDMI, Jack, D-Sub, D-Sub mini, circular connector, sockets etc.

As is shown in FIG. 1, the connection compartment 301 internally comprises the electronic connector 5. The connection compartment 301 is open to the internal space 32. The user can thus couple or change using simple plug-and-play fitting with the connection compartment 301.

Of course, the cleaning device 1 does not necessarily include a recharging device 4. By way of example, this makes it possible for a user to connect to the cleaning device 1 a recharging device 4 provided by the maker of the hearing aid 2.

To recharge the battery of the hearing aid 2, the recharging device 4 is connected to electronic means 6. The electronic connector 5 connects the recharging device 4 to the electronic means 6.

The electronic means 6 are suitable for controlling the operation of the recharging device 4 in particular by managing the power supply thereof. In particular, the maintenance device 1 comprises power supply means 60 for a household mains system and/or a battery for powering the recharging device 4.

Conventionally, the electronic means 6 comprise in particular a microcontroller equipped with a memory and mounted on an electronic card 61.

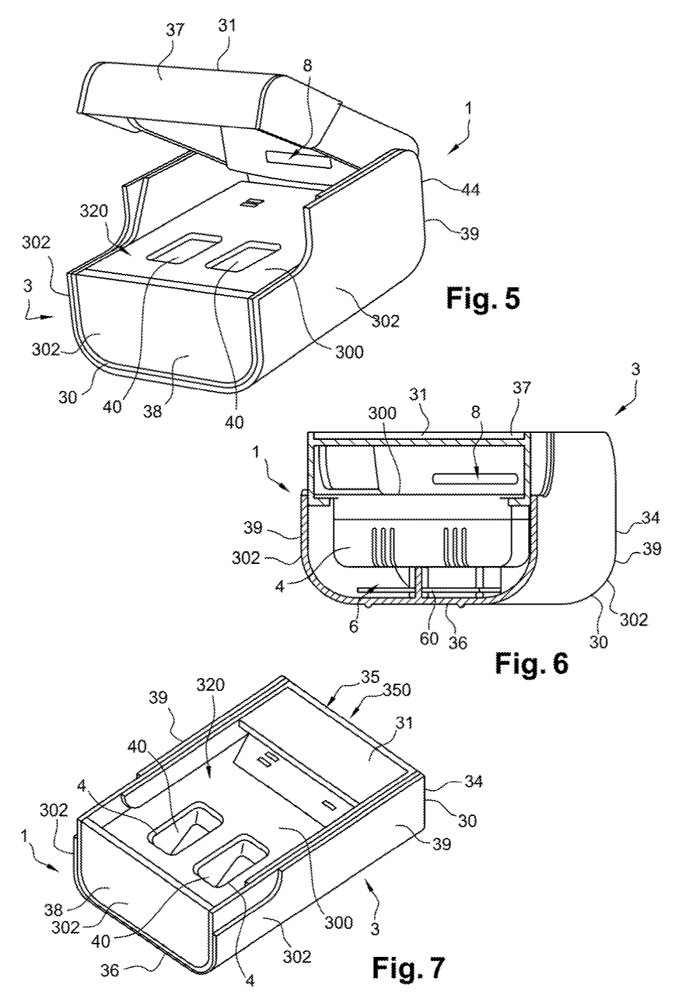

Depending on the type of hearing aid 2 for which it is intended, the recharging device 4 comprises battery charging means using electric contact (shown in FIGS. 2 and 3). The recharging device 4 may also comprise battery charging means free of electric contact (shown in FIGS. 5 to 7). For example, the contact-free charging means may be formed by magnetic resonance charging means.

Advantageously, the maintenance device 1 is equipped with drying means 7; it is thus possible to dry and recharge a hearing aid 2 using a single device that comprises a removable recharging device 4. Preferably, the hearing aid 2 is dried and the battery thereof is recharged within a single maintenance cycle.

However, the maintenance device 1 may also be used to implement a simple drying cycle. This is possible if the recharging device 4 is not associated with the cleaning device. A simple drying cycle may also be implemented if the recharging device 4 is not called upon by the user. This is possible if the user deposits his hearing aids on the receiving plate 300 so as to implement a drying cycle but without connecting the hearing aids to the recharging device 4.

With this in mind, the electronic means 6 also control the drying means 7 so as to create an airflow that dries the hearing aid 2. Thus, the electronic means 6 manage the maintenance cycle of the hearing aid 2.

As is shown in FIG. 1, the drying means 7 comprise an air circulation system. For this purpose, the drying means 7 comprise an air entry orifice 70 and an air evacuation orifice 71 that are configured so as to create air circulation. Preferably, the air entry orifice 70 is arranged at the lower face 36 of the casing 3. However, the air entry orifice 70 may be arranged laterally in the lower part of the casing 3. By way of illustration, the air entry orifice may be arranged in the lower part of a side face 39, of the front face 38 or of the rear face 34 of the casing 3. The lower part of each face 34, 38, 39 corresponds to a part close to the lower face 36 of the casing 3.

The air entry orifice 70 may be implemented in the form of a grouping of small perforations formed in the lower face 36 of the base 30. The air entry orifice 70 may also be formed by small perforations, by one or more circular perforations, by an oblong hole, by a conical hole, by a square-barred grid, by tangent grooves, or by a turbulence hole etc.

Conversely, the air evacuation orifice 71 may be arranged laterally, on a side face 39, on the front face 38 or on the rear face 34 of the casing 3. Preferably, the air evacuation orifice 71 is arranged at the cover 31; more advantageously, the air evacuation orifice 71 is arranged at the hinge 33. Advantageously, the articulation of the cover 31 to the casing 3 at the hinge 33 creates a slit of a design that is ingeniously used as an air evacuation orifice 71 (shown in FIGS. 1 to 4).

In the example shown in FIGS. 2 to 4, the casing 3 comprises an internal wall 321 that extends from a first side 330 of the hinge 33 to a second side 331 of the hinge 33. The internal wall 321 forms an internal shoulder with walls 302 of the base 30. The internal wall 321 sits on the walls 302 and forms the upper perimeter of the base 30 of the casing 3. The walls 302 define the external contours of the casing 3 and correspond to the front 38, rear 34 and side 39 faces of the base 30 of the casing 3.

To optimize the channeling of the airflow at the maintenance enclosure 320, the cover 31 comprises lower edges 310 that cover the internal wall 321 at least in part. This cooperation between the cover 31 and the internal wall 321 of the casing 3 provides air-tightness at the covered regions of the internal wall 321 and is involved in creating the airflow.

As is shown in FIGS. 1 and 3, the drying means 7 comprise a heating system 72 that makes it possible to heat the airflow. The heating system 72 may be formed by resistors that, in a known manner, emit heat when passed through by an electric current.

In the present case, the heating system 72 is arranged in a heating chamber 73 that is positioned below the maintenance enclosure 320. The heating chamber 73 is open to the exterior of the casing 3 via the air entry orifice 70. In this example, the heating system 72 is positioned directly above the air entry orifice 70.

Moreover, the heating chamber 73 communicates with the maintenance enclosure 320 via at least one opening 74. Preferably, the opening 74 is formed in a floor 303 of the receiving plate 300. In this example, the opening 74 may be formed by interruptions in the form of grooves formed in the floor 303 of the receiving plate 300. The opening 74 may also be formed by small perforations, by one or more circular perforations, by an oblong hole, by a conical hole, by a square-barred grid, by tangent grooves, or by a turbulence hole etc.

Advantageously, the drying means 7 comprise a temperature sensor 75 to regulate the temperature of the airflow propelled into the maintenance enclosure 320. Preferably, the temperature sensor 75 is located in the direct vicinity of the heating system 72. For this purpose, as is shown in FIG. 1, the temperature sensor 75 is arranged inside the heating chamber 73. In particular, a hearing aid 3 comprises a set of heat-sensitive electronic elements. In general, the makers of hearing aids 3 advise against exposing hearing aids to temperatures greater than 40° C., Thus, the temperature sensor 75, as a result of its positioning, makes it possible to detect, in the heating chamber 73, an increase in temperature above a determined threshold. The temperature threshold may for example be set to 30° C.

Since the temperature sensor 75 and the heating system 72 are controlled by electronic means 6, if the temperature sensor 75 detects a temperature above the determined threshold, the electronic means 6 regulate and/or stop the operation of the heating system 72.

As is shown in FIG. 1, an airflow A arrives in the internal space 32 and the air circulation system at the heating chamber 73 via the air entry orifice 70. The incoming airflow A is then heated by the heating system 72, which brings about dilation of the incoming airflow A. This dilation of the airflow brings about a transfer of the heated airflow B from the heating chamber 73 towards the maintenance space 320. The propulsion of the heated airflow upwards through the opening 74 and the lateral positioning of the air evacuation orifice 71 together bring about turbulence C in the heated airflow within the maintenance space 320. In particular, the coaxial arrangement between the air entry orifice 70, the heating system 72 and the opening 74 contributes to the generation of a rising airflow that experiences turbulence C when it arrives in the maintenance space 320. Moreover, the eccentric position of the air evacuation orifice 71 promotes the rising airflow undergoing turbulence C.

This turbulence C makes it possible to optimize the drying of the hearing aid 2. The outgoing airflow D is subsequently evacuated via the air evacuation orifice 71 by a pressure-balance phenomenon.

In the example shown in FIG. 1, the maintenance device 1 comprises a disinfection module 8 for disinfecting the hearing aid 2 by electromagnetic irradiation 800. The disinfection module 8 may be formed by a UVC lamp. Preferably, the disinfection module 8 is arranged at the cover 31, promoting homogeneous electromagnetic irradiation 800 of the maintenance enclosure 320. In the present case, the disinfection module 8 is positioned inside the hood of the cover 31 at the join between the front face 38 and the upper face 37 of the casing 3. As a result of this position, the disinfection module 8 irradiates the maintenance space 320 and the hearing aid or hearing aids 2 arranged therein.

The disinfection module 8 is also connected to electronic means 6 via a power cable 80. In the present case, the power cable 80 links the disinfection module 8 and the electronic means 6 via a partitioned space 81 arranged between the hood of the cover 31 and the maintenance space 320. The power cable 80 continues its path through the hinge 33 of the casing 3. The electronic means 6 thus control the disinfection module 8 by managing the electric power supply thereof.

Advantageously, the power cable 80 comprises a contact breaker 81 for powering the disinfection module 8 when the cover 31 is in the closed position. Moreover, for reasons of user safety, the contact breaker 82 is also suitable for cutting the power to the disinfection module 80 when the cover 31 starts on the opening path thereof.

For this purpose, the contact breaker 82 is of the contactor type and is preferably positioned at the hinge 33. In this configuration, a first part 83 of the contact breaker 82 is fixed and positioned on the base 30 in the vicinity of the hinge 33, whilst a second part 84 of the contact breaker 82 is movable and positioned at the bottom of the cover 31 in the vicinity of the hinge 33. When the cover 31 is in the closed position, the first part 83 and the second part 84 are positioned along a single axis so as to be in contact with one another and to make it possible to power the disinfection module 8. Moreover, when the cover 31 starts on the opening path thereof, the two parts 83, 84 are no longer in contact, and the power to the disinfection module 8 is thus immediately cut.

It should be noted that the contact breaker 82 may also be electromagnetic. In this case, the contact breaker 82 comprises a permanent magnet and a magnetic field sensor. In this case, the cover 31 may comprise the permanent magnet, whilst the magnetic field sensor is arranged at the base 30. However, the arrangement of the magnetic field sensor and permanent magnet may be reversed. By using an electromagnetic contact breaker 82, the disinfection module 8 may be arranged at any point in the maintenance space 320, for example at the base 30 or at the cover 31.

This feature makes it possible to prevent the user from being exposed to the electromagnetic irradiation 800 of the disinfection module 8. In the cased of a UVC lamp, the UVC irradiation can harm the user's eyes in particular.

With a view to the user's safety and comfort, the maintenance device comprises at least one indicator light 9 arranged at the front face 38 of the casing 3. The indicator light 9 is also connected and controlled by the electronic means 6. Depending on the color thereof, it may indicate to the user whether the maintenance cycle is underway or else whether the maintenance cycle is finished.

FIG. 7 shows an alternative embodiment of the cover 31. In this example, the cover 31 is mounted movably by sliding along a groove arranged in the internal space 32 of the casing 3. In the present case, the cover 31 has the nature of a flexible panel. When the cover 31 is in the closed position, a viewing hole 350 is arranged hidden in the joining region 35. This viewing hole 350 advantageously serves as an air evacuation orifice.

In a possible variant (not shown) of the invention, the drying means 7 may comprise a fan for accelerating the airflow. In this case, the fan is arranged at the heating chamber 71 upstream and/or downstream from the heating system 70.

The use of a fan is of interest, for example, in the case of a recharging device 4 using electric contact; the fan makes it possible to prevent oxidization of electric contact elements of the hearing aid 2 by accelerating the drying of the hearing aid 2.

The fan may also be beneficial in the case of a quick-action recharging device 4. In this case, it makes it possible to reduce the duration of the maintenance cycle of the hearing aid 2.

The invention further relates to a kit for maintaining at least one hearing aid comprising the maintenance device 1 equipped with a removable recharging device 4.

1. A maintenance device for at least one hearing aid equipped with a rechargeable battery, the maintenance device comprising:
a casing having a base equipped with a cover mounted movable between an open position and a closed position in which the internal space of the casing defines a maintenance enclosure,
wherein said casing comprises:
a plate for receiving a hearing aid;
means for drying the hearing aid (2); and
at the maintenance space, a connection compartment arranged in the receiving plate, the connection compartment internally comprising an electronic connector for transmitting an electric current and/or a data exchange, the connection compartment removably receiving the device for recharging the rechargeable battery of the hearing aid, the recharging device being connected to the casing via the electronic connector.

2. The maintenance device, according to claim 1, further comprising:
electronic means that control the drying means for creating an airflow that brings about the drying of the hearing aid, and a recharging device when it is connected to the electronic connector (5).

3. The maintenance device, according to claim 1, wherein the drying means comprise a fan for accelerating the circulation of an airflow that enters the casing.

4. The maintenance device, according to claim 1, wherein the drying means comprise an air entry orifice and an air evacuation orifice that are configured to create an airflow, the air entry orifice being arranged at a lower face of the casing whilst the air evacuation orifice is arranged laterally with respect to the casing.

5. The maintenance device, according to claim 4, wherein the air evacuation orifice is arranged at the cover, the air evacuation orifice preferably being arranged at a hinge that articulates the cover with respect to the casing.

6. The maintenance device, according to claim 1, wherein the drying means comprise a system for heating an incoming airflow.

7. The maintenance device, according to claim 6, wherein the heating system is arranged in a heating chamber.

8. The maintenance device according to claim 7, wherein the heating chamber is arranged below the maintenance space, the heating chamber comprising a temperature sensor to regulate the temperature of an airflow in the casing, the temperature sensor being located in the vicinity of the heating system.

9. The maintenance device, according to claim 7, wherein the heating chamber is open to the exterior of the casing via an air entry orifice and wherein the heating chamber communicates with the maintenance enclosure via at least one opening.

10. The maintenance device, according to claim 9, wherein the air entry orifice, the heating system and the opening are arranged coaxially, and thus contribute to the generation of a rising airflow that experiences turbulence when it arrives in the maintenance space.

11. The maintenance device, according to claim 1, further comprising:
a disinfection module for the hearing aid by electromagnetic irradiation, the disinfection module being arranged at the cover.

12. The maintenance device, according to claim 11, further comprising:
a contact breaker powering the disinfection module when the cover is in the closed position and cutting the power supply to the disinfection module when the cover is open.

13. A kit for maintaining at least one hearing aid comprising:
a recharging device; and
a maintenance device according to claim 1,
wherein the maintenance device comprises
a connection compartment that internally comprises an electronic connector for transmitting an electric current and/or a data exchange, the connection compartment being suitable for removably receiving the device for recharging the rechargeable battery of the hearing aid, the recharging device being connected to the casing via the electronic connector.
